(19) United States
(12) Patent Application Publication
(10) Pub. No.: US 2002/0134238 A1
(43) Pub. Date: Sep. 26, 2002

(54) Vacuum cleaner utilizing electrostatic filtration and electrostatic precipitator for use therein

(76) Inventors: Wayne Ernest Conrad, Hampton (CA); Dave Andrew Petersen, Courtice (CA); Tony True, Oshawa (CA)

Correspondence Address: Philip C. Mendes da Costa, Bereskin & Parr, 40 King Street West, Box 401, Toronto, ON, M5H 3Y2, CA

(21) Appl. No.: 09/970,085

(22) Filed: Oct. 4, 2001

(30) Foreign Application Priority Data
Mar. 6, 2001 (CA) 2,339,514

(51) Int. Cl. B03C 3/00

(52) U.S. Cl. 95/79

(57) ABSTRACT

An electrostatic filter assembly is provided that utilizes electrostatic forces to attract charged particulate matter entrained in a fluid stream to the operating elements in the electrostatic filter assembly and a residual charge between the particulate matter and the electrostatic filter assembly to retain the separated material in the electrostatic filter assembly.

### FIELD OF THE INVENTION

This invention relates to electrostatic precipitators. In one embodiment, the invention relates to a vacuum cleaner which includes the electrostatic precipitator. The vacuum cleaner may have a cyclonic separation apparatus upstream of the electrostatic precipitator.

### BACKGROUND OF THE INVENTION

Cyclone separators, which are sometimes referred to merely as cyclones, are devices that utilize centrifugal forces and low pressure caused by spinning motion to separate materials of differing density, size and shape. FIG. 1 illustrates the operating principles in a typical cyclone separator (designated by reference numeral 10 in FIG. 1). The following is a description of the operating principles of cyclone separator 10 in terms of its application to removing entrained particles from an air stream in a vacuum cleaner.

Cyclone separator 10 has an inlet pipe 12 and a main body comprising upper cylindrical portion 14 and lower frusto-conical portion 16. The particle laden air stream is injected through inlet pipe 12 which is positioned tangentially to upper cylindrical portion 14. The shape of upper cylindrical portion 14 and frusto-conical portion 16 induces the air stream to spin creating a vortex. Larger or more dense particles are forced outwards to the walls of cyclone separator 10 where the drag of the spinning air as well as the force of gravity causes them to fall down the walls into an outlet or collector 18. The lighter or less dense particles, as well as the air medium itself, reverses course at approximately collector G and pass outwardly through the low pressure centre of separator 10 and exit separator 10 via air outlet 20 which is positioned in the upper portion of upper cylindrical portion 14.

The separation process in cyclones generally requires a steady flow free of fluctuations or short term variations in the flow rate. The inlet and outlets of cyclone separators are typically operated open to the atmosphere so that there is no pressure difference between the two. If one of the outlets must be operated at a back pressure, both outlets would typically be kept at the same pressure.

When a cyclone separator is designed, the principal factors which are typically considered are the efficiency of the cyclone separator in removing particles of different diameters and the pressure drop associated with the cyclone operation. The principle geometric factors which are used in designing a cyclone separator are the inlet height (A); the inlet width (B); the air outlet diameter (C); the outlet duct length (D); the cone height (Lc); the dirt outlet diameter (G);and, the cylinder height (L)

The value d₅₀ represents the smallest diameter particle of which 50 percent is removed by the cyclone. Current cyclones have a limitation that the geometry controls the particle removal efficiency for a given particle diameter. The dimensions which may be varied to alter the d₅₀ value are features (A)-(D), (G), (L) and (Lc) which are listed above.

Typically, there are four ways to increase the small particle removal efficiency of a cyclone. These are (1) reducing the cyclone diameter; (2) reducing the outlet diameter; (3) reducing the cone angle; and (4) increasing the body length. If it is acceptable to increase the pressure drop, then an increase in the pressure drop will (1) increase the particle capture efficiency; (2) increase the capacity and (3) decrease the underflow to throughput ratio.

In terms of importance, it appears that the most important parameter is the cyclone diameter. A smaller cyclone diameter implies a smaller d₅₀ value by virtue of the higher cyclone speeds and the higher centrifugal forces which may be achieved. For two cyclones of the same diameter, the next most important design parameter appears to be L/d, namely the length of the cylindrical section 14 divided by the diameter of the cyclone and Lc/d, the length of the conical section 16 divided by the width of the cone. Varying L/d and Lc/d will affect the d₅₀ performance of the separation process in the cyclone.

Due to its intended use, a vacuum cleaners is designed to filter particles of varying sizes from an air stream. With most vacuum cleaners on the market, a filter material such as a paper bag is used to filter the air. The bag will remove from the air stream any particle larger than the size of the pore in the bag. Thus only a single stage of filtration may be employed. However, if a cyclone is used in a vacuum cleaner, then multiple filtration stages may be employed. This is due to the fact that particle sizes which are generally to be filtered by a vacuum cleaner take on a spectrum of values that necessitates that a plurality of cyclonic separators be used in a series. For example, the first cyclonic separator in a series may have a large d₅₀ specification followed by one with a smaller d₅₀ specification.

For example, in U.S. Pat. No. 3,425,192, a vacuum cleaning assembly was disclosed which used a first frusto-conical cyclone and six secondary cyclones.

More recently, cyclonic technology has been improved and introduced commercially into canister and upright vacuum cleaners. See for example U.S. Pat. No. 4,593,429. This patent discloses a vacuum cleaner design in which sequential cyclones are utilized as the filtration medium for a vacuum cleaner. Pursuant to the teaching of this patent, the first sequential cyclone is designed to be of a lower efficiency to remove only the larger particles which are entrained in an air stream. The smaller particles remain entrained in the air stream and are transported to the second sequential cyclone which is frusto-conical in shape. The second sequential cyclone is designed to remove the smaller particles which are entrained in the air stream. If larger particles are carried over into the second cyclone separator, then they will typically not be removed by the cyclone separator but exit the frusto-conical cyclone with the air stream.

One disadvantage of cyclonic vacuum cleaners is the amount of power which is required to create an air flow sufficient to convey the dirty air through the cyclones at sufficient speeds to maintain the air flowing cyclonically through the cyclones.

### SUMMARY OF THE INVENTION

The electronic filter of the instant invention may be used in any application where charged particulate matter is to be removed from a fluid stream. The electrostatic precipitator of the instant invention permits a high level of filtration (e.g. up to 99%) of charged particulate matter from a fluid steam over a relatively short distance (e.g 5 cm) at a relatively high flow rate (e.g. 2.5 cm/s). The electronic filter may be used in any application known in the art.

In order to achieve high levels of particle removal, cyclonic vacuum cleaners which are currently on the market incorporate a HEPA™ filter. Such filters are effective in removing small particulate matter from the air stream so that the air which exits the vacuum cleaner is essentially completely filtered. One disadvantage of such HEPA™ filters is that they provide substantial resistance to the flow of air there through. By removing the HEPA™ filter, the pressure drop which occurs during the passage of the air through the filter assembly of a vacuum cleaner may be reduced by, eg., up to 20%. Accordingly, by removing the HEPA™ filter, the flow rate through the vacuum cleaner may be substantially increased and/or the size of the motor may be reduced by eg., up to 20%. However, the amount of particulate matter which will be contained in the dirty air stream will be increased.

The instant invention provides an alternate approach to the use of such HEPA™ filters. Electrostatic filters generally provide minimal resistance to the flow of air and accordingly do not generally provide much of the pressure drop as an air stream passes there through. The electrostatic filter may be designed to remove the same size particles as are removed by the HEPA™ filter which is currently in use. Alternately, the electrostatic filter may be designed to remove even larger particles. Accordingly, by using an electrostatic filter, the pressure drops for a vacuum cleaner may be substantially reduced (compared to a vacuum cleaner using a HEPA™ filter). Further, the electrostatic filter may provide enhanced particle remover compared to even a HEPA™ filter and accordingly the clean air outlet from the vacuum cleaner may produce air which is even cleaner than that which is achieved from commercially available cyclonic vacuum cleaners which even incorporate a HEPA™ filter.

The electronic filter is particularly advantageous when used in a vacuum cleaner. A vacuum cleaner may have a high flow rate of air there through. If a significant amount of entrained material is contained in the filtered air leaving the vacuum cleaner, then this material is redistributed in the room being cleaned. The electronic filter according to the instant invention filters up to 95% and, preferably, up to 99% or more of fine particulate matter from an air stream. Thus, this filter, together with conventional filtration technology, could be used to produce a vacuum cleaner which has a HEPA level of filtration without the use of HEPA filter material. However, it will be appreciated that not only may it be used in place of any current electronic filter but, due to the low back pressure produced by the flow of a gas through the electronic filter, that it may be used in various applications which heretofore have used physical filtration media. Further, due to its high efficiency over a short distance (e.g 3-4 inches), it may be used in various applications not previously envisioned for electronic filters. Further, as in one preferred embodiment it operates passively (i.e. it is inductively charged by the passage of particles there through), it may be used in mobile applications where a large current supply may not be conveniently provided (e.g. cars).

In one particular embodiment, the filter is used upstream from a cyclone. The filter may be a pre-motor filter, a post -motor filter and more preferably, two filters may be used, one pre-motor and the other post-motor. The particulate matter may be tribocharged as it travels through the cyclone thus permitting a passive electrostatic filter to be used. This construction greatly simplifies the construction of a vacuum cleaner since the electrostatic precipitator need not be wired to a high voltage source.

In accordance with the instant invention, there is provided a vacuum cleaner comprising a vacuum cleaner head having a dirty air inlet and an air flow path there through for transporting particulate material entrained in air passing through the air flow path, the air flow path in fluid flow communication with a source of suction: and, a filter assembly comprising a plurality of spaced apart, electrically conductive members defining an air flow path through the electronic filter, and at least one porous, non-conductive spacing member positioned in the air flow path between at least two adjacent electrically conductive members, each porous, non-conductive spacing member having first and second opposed sides, the first opposed side positioned adjacent a first electrically conductive member and the second opposed side positioned adjacent a second electrically conductive member wherein, in use, the first and second electrically conductive members have different potentials sufficient to produce polarized charges at the first and second opposed surfaces of a spacing member.

In one embodiment, the electrically conductive members comprise porous electrically conductive plates.

In another embodiment, the electrically conductive plates are constructed from expanded metal.

In another embodiment, the air flow path is a convoluted path.

In another embodiment, the electrically conductive porous plates are chargeably connected to a current source.

In another embodiment, the vacuum cleaner further comprises a charging member to charge the particulate material whereby the electrically conductive porous plates are inductively charged by the particulate material.

In another embodiment, the vacuum cleaner further comprises a cyclone whereby the particulate material is tribocharged during its passage through the cyclone and the electrically conductive porous plates are inductively charged by the particulate material.

In another embodiment, the electrically conductive members are of the same polarity.

In another embodiment, the electrically conductive members and the non-conductive spacing members define an electronic filter which has an upstream end, a downstream end and a central portion and the central portion is operated at a higher potential then the downstream end.

In another embodiment, the central portion is operated at a higher potential then the downstream end and the upstream end.

In another embodiment, adjacent electrically conductive members have a difference in potential of at least 1,000 volts.

In another embodiment, adjacent electrically conductive members have a difference in potential which varies from about 1,000 to 2,500 volts.

In another embodiment, adjacent electrically conductive members have a difference in potential of at least 10%.

In another embodiment, one electrically conductive member having the highest potential is connectable to a high voltage source and the other electrically conductive members are electrically connected to the plate having the highest potential via at least one resistor whereby the flow of the current through the at least one resistor reduces the voltage of the current provided to the other plates.

In another embodiment, one electrically conductive member having the highest potential is connectable to a high voltage source and the other electrically conductive members are charged by selecting the non-conductive layer to permit current leakage to pass there through whereby the other plates are charged by the current leakage.

In another embodiment, the electrically conductive members and the non-conductive spacing members define an electronic filter and the electronic filter has an upstream end and a downstream end and a ground electrode is positioned adjacent the upstream end and the downstream end.

In accordance with the instant invention, there is also provided an electronic filter having an upstream end and a downstream end, the electronic filter comprising a plurality of spaced apart, electrically conductive porous plates, each plate having an upstream side and a downstream side; and, a porous dielectric layer positioned between adjacent conductive plates, each electrically insulating layer having an upstream side and a downstream side.

In one embodiment, each electrically insulating layer comprises a plurality of non-conductive fibres.

In another embodiment, the plates are of the same polarity.

In another embodiment, the filter has an upstream end, a downstream end and a central portion and the central portion is operated at a higher potential then the downstream end.

In another embodiment, the filter has an upstream end, a downstream end and a central portion and the central portion is operated at a higher potential then the downstream end and the upstream end.

In another embodiment, adjacent plates have a difference in potential of at least 1,000 volts.

In another embodiment, one plate having the highest potential is connectable to a high voltage source and the other plates are electrically connected to the plate having the highest potential via at least one resistor whereby the flow of the current through the at least one resistor reduces the voltage of the current provided to the other plates.

In another embodiment, one plate having the highest potential is connectable to a high voltage source and the other plates are charged by selecting the electrically insulating layer to permit current leakage to pass there through whereby the other plates are charged by the current leakage.

In accordance with the instant invention, there is also provided a method of filtering a gas containing entrained material comprising the step of sequentially passing the gas through a plurality of non-conductive members which are interspersed between zones of different potential wherein adjacent zones have a potential difference sufficient to induce different polarities on different portions of a non-conductive filter member positioned between the adjacent zones.

In one embodiment, the zones of different potential are of the same polarity and the method further comprises passing the gas through zones of different potential but of the same polarity.

In another embodiment, the polarity of the zones alternates between adjacent non-conductive members and the method further comprises passing the gas through zones of different polarity.

In another embodiment, the method further comprises the step of tribocharging the entrained material prior to passing the gas through the filter.

In accordance with the instant invention, there is also provided a vacuum cleaner comprising a vacuum cleaner head having a dirty air inlet and an air flow path there through for transporting particulate material entrained in air passing through the air flow path, the air flow path in fluid flow communication with a source of suction: and, a plurality of spaced apart, electrically conductive members positioned in series in the conduit, the electrically conductive members having a conductivity selected to leave a residual charge on the particulate matter which is sufficient to retain particulate matter on the electrically conductive members.

In one embodiment, the electrically conductive members comprise porous electrically conductive plates.

In another embodiment, the vacuum cleaner further comprises a charging member to charge the particulate material whereby the electrically conductive members are inductively charged by the particulate material.

In another embodiment, the vacuum cleaner further comprises a cyclone whereby the particulate material is tribocharged during its passage through the cyclone and the electrically conductive members are inductively charged by the particulate material.

In accordance with the instant invention, there is also provided an electronic filter comprising a conduit defining a gas flow path through which a gas having entrained particulate matter travels; and, a plurality of spaced apart, electrically conductive members positioned in the conduit, the electrically conductive members having a conductivity selected to leave a residual charge on the particulate matter which is sufficient to retain the particulate matter in the electronic filter.

In one embodiment, the electrically conductive members comprise porous electrically conductive plates.

In another embodiment, the electrically conductive members are constructed from a conductive material which is coated with an electrical insulating layer.

In another embodiment, the coating is selected from the group consisting of an oxide of silicon, plastic, a dielectric, a ceramic and a combination thereof.

In another embodiment, the electrically conductive members are constructed from aluminum.

In another embodiment, the electrically conductive members are electrically insulated from a ground such that the particulate matter inductively charges the plates as it passes through the electronic filter.

In another embodiment, the electrically conductive members are constructed from stainless steel.

In another embodiment, the residual charge is from 700 v to 10 Kv.

In another embodiment, the residual charge is from 2.5 to 7 Kv.

In another embodiment, the residual charge is from 5 to 6 Kv.

In another embodiment, the gas flow path is a convoluted path through the electronic filter.

In another embodiment, the plates are constructed from aluminum mesh and electronic filter comprises from 1-200 plates.

In another embodiment, the plates are constructed from aluminum mesh and electronic filter comprises from 20-120 plates.

In another embodiment, the plates are constructed from aluminum mesh and electronic filter comprises from 40-100 plates.

In accordance with the instant invention, there is also provided an electronic filter comprising conduit means extending through the electronic filter through which a gas having entrained particulate matter travels; and, electrically conductive means positioned in the conduit means, the electrically conductive means having a conductivity selected to leave a residual charge on the particulate matter which is sufficient to retain particulate matter on the electrically conductive means.

In one embodiment, the electrically conductive means define a series of porous members which are positioned such that the gas flows through several of the porous members as it travels through the electronic filter.

In another embodiment, the electrically conductive means are coated with an electrical insulating layer.

In another embodiment, the coating is selected from the group consisting of an oxide of silicon, plastic, a dielectric, a ceramic and a combination thereof.

In another embodiment, the electrically conductive means are constructed from aluminum.

In another embodiment, the electronic filter further comprises means for electrically insulating the electrically conductive means from a ground such that the particulate matter inductively charges the plates as it passes through the electronic filter.

In another embodiment, the electrically conductive members are constructed from stainless steel.

In another embodiment, the conduit means is a convoluted path through the electronic filter.

In another embodiment, the plates are constructed from aluminum mesh and electronic filter comprises from 1-200 plates.

In accordance with the instant invention, there is also provided a method of filtering a gas containing entrained particulate matter comprising the steps of providing a gas containing charged entrained particulate matter and passing the gas through a plurality of electrically conductive members whereby the potential on the conductive members and the conducitivity of the entrained particulate matter leave a residual charge on the particulate matter which is sufficient to retain the particulate matter on the electrically conductive members.

In one embodiment, the entrained particulate matter has the conductivity of the particulate matter is that of a dilelectric element.

In another embodiment, the electrically condcutive members are electrically insulated from each other and are inductively charged by the passage of entrained particulate matter therethrough.

In another embodiment, the method further comprises the step of tribocharging the entrained material prior to passing the gas through the filter.

### BRIEF DESCRIPTION OF THE DRAWINGS

These and other advantages of the instant invention will be more fully and particularly understood in connection with the following description of the preferred embodiments of the invention in which:

FIG. 1 is a cyclone separator as is known in the art;

FIG. 2 is a perspective view of an upright vacuum cleaner according to the instant invention;

FIG. 3 is a cross-section along line 2-2 in FIG. 2 of the vacuum cleaner of FIG. 2;

FIG. 4 is an enlargement of the upper portion of the cyclone chamber when positioned in the housing of the vacuum cleaner of FIG. 2;

FIG. 5 is an exploded view of the cyclone chamber and housing of the vacuum cleaner of FIG. 2;

FIG. 6 is a perspective view of the cyclone chamber when removed from the housing of the vacuum cleaner of FIG. 2;

FIG. 7 is an exploded view of the cyclone chamber of FIG. 6;

FIG. 8 is a exploded view of a cyclone assembly including an electrostatic precipitator according to the instant invention;

FIG. 9 is a cross-section through an electrically conductive plate according to the instant invention;

FIG. 10 is a cross-section through an alternate embodiment of an electrically constructive member according to the instant invention.

FIG. 11 is a cross section of an electrostatic filter according to one embodiment of the instant invention;

FIG. 12 is a cross section of an electrostatic filter according to another embodiment of the instant invention;

FIG. 13 is a stylized cross section through a portion of an electrostatic filter which uses a sandwiched construction of alternating conductive and non-conductive layers;

FIG. 14 is a perspective view of an electrostatic precipitator according to another embodiment of the instant invention;

FIG. 15 is a cross section along the line 16-16 of the electrostatic filter of FIG. 14;

FIG. 16 is an enlarged perspective view of a portion of the electrostatic precipitator of FIG. 14;

FIG. 17 is schematic drawing of another embodiment of an electrostatic filter according to another embodiment of the instant invention; and,

FIG. 18 is an exploded view of a housing for an electrostatic precipitator.

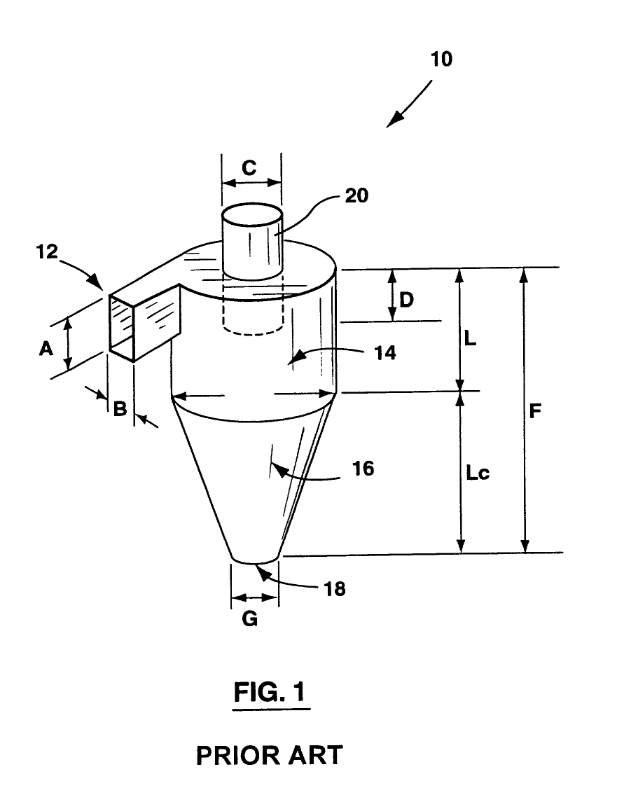

### DETAILED DESCRIPTION OF THE PREFERRED EMBODIMENT

While it is to be appreciated that the electronic filter may be used in any field of industry which used electronic filtration and in various diverse domestic applications (e.g air cleaners for furnaces, room air cleaners, etc.), the preferred embodiments are discussed in the context of a vacuum cleaner. For example, the filter assembly may be used for an upright vacuum cleaner, a canister vacuum cleaner or a central vacuum cleaner or the like. The dirty air stream which is processed using the filter assembly described herein may be collected by, for example, a wand or rotating brush positioned in the head of a vacuum cleaner as is known in the art. Such dirty air streams typically comprise dirt of varying particle sizes entrained in an air stream. It will be appreciated that the invention may also be used with a wet/dry vacuum cleaner.

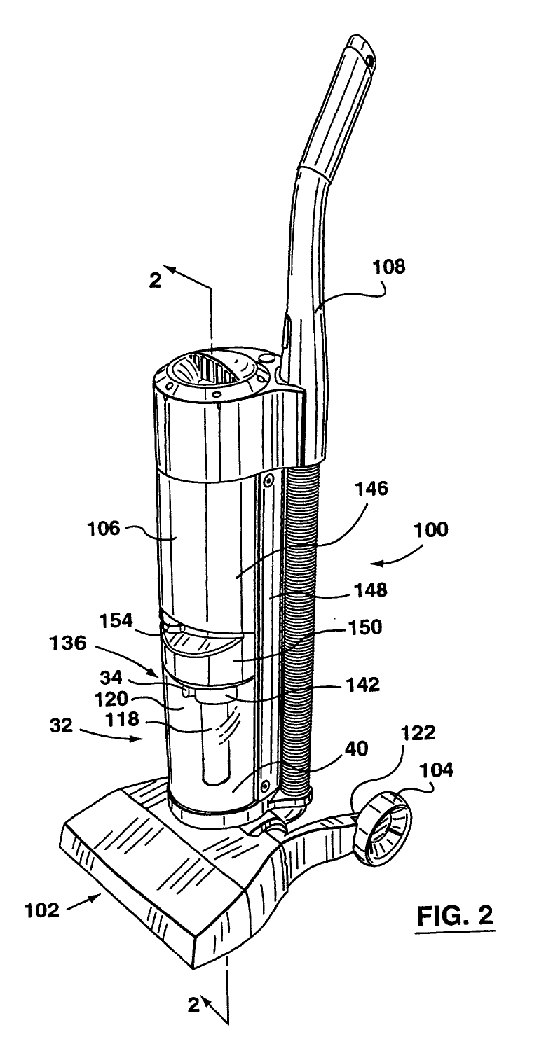

The electronic filter assembly may be used downstream from any filter design known in the vacuum art and preferably downstream from at least one cyclone. For example, the cyclone may be a frusto-conical cyclone or a cylindrical cyclone (see FIG. 2) having a dirty air feed conduit which is positioned exterior to cyclone bin 120.

The vacuum cleaner may have a filter assembly comprising at least one first stage cyclone. The first stage cyclone may, if desired, comprise a plurality of individual cyclones through which the air passes either in sequence or in parallel. Preferably, the filter assembly uses only one first stage cyclone. Such a single cyclone may be designed to remove approximately 90% or more, preferably at least 95% and most preferably at least 98% of the particulate matter in the air stream entrained by the vacuum cleaner.

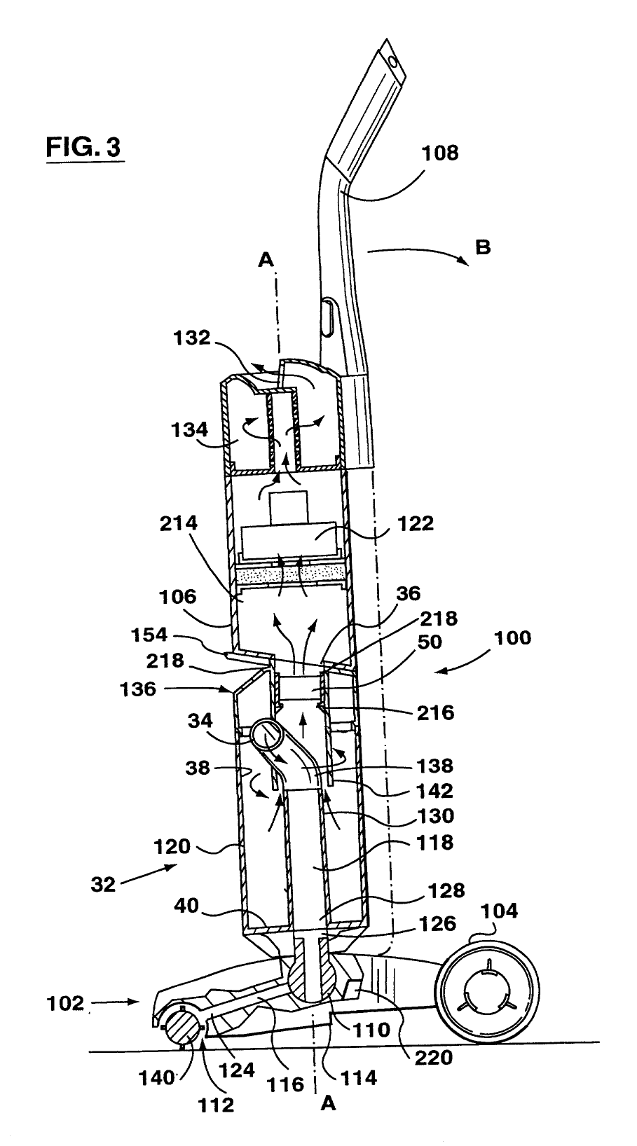

The dirty air may be introduced into the cyclone by any means known in the art. The dirty air may be introduced tangentially into cyclone 32. As shown in FIG. 3, cyclone 32 may comprise a container or bin 120 having bottom 40 and side walls 38. It will be appreciated that container 120 may be of any particular configuration. Inlet 34 is in communication with the source of dirty air via an inlet conduit. The inlet conduit may be of any configuration known in the art which will convey the dirty air from a source (eg. a cleaning wand or the floor engaging head of a vacuum cleaner) to inlet 34. The dirty air travels around container 120 towards bottom 40. At one point, the air travels upwardly adjacent the central portion of container 120 to exit cyclone 32 by outlet 36. As shown herein, outlet 36 comprises an annular member which extends downwardly into the upper portion of cyclone 32 so as to prevent the partially cleaned air travelling upwardly through outlet 36 from mixing with the dirty air introduced via inlet 34.

As shown in FIG. 3, the partially cleaned air exiting first stage cyclone 32 via outlet 36 is next passed through an electronic filter 50. Filter 50 may be positioned in air flow communication with outlet 36 in any manner. Filter 50 may be held in position in the air flow path by any means known in the art and is preferably removably mounted in the air flow path.

Container 120 is preferably removable from the vacuum cleaner by any means known in the art. When the container comprising bottom 40 and sidewalls 38 is positioned in the vacuum cleaner, it may abut against lower panel 54 in sealing engagement so as to provide an air tight enclosure but for outlet 36.

The further cleaned air which exits electronic filter 50 may pass through outlet 36 to a one or more second stage cyclones. The number of second stage cyclones may vary depending upon, inter alia, the type of particulate matter which is to be filtered, the degree of separation which is required and the amount of pressure drop which is acceptable based upon the motor which is provided to the vacuum cleaner. The second cyclones may also be of any particular design known in the art and may be the same or different from first stage cyclone 32. Further, each second stage cyclone need not be the same.

Vacuum cleaner 100 has a floor cleaning head 102, means for moving cleaning head 102 across a floor (eg. wheels which may comprise rear wheels 104 or front wheels and rear wheels 104), an upper body portion or housing 106 rotatably attached to cleaning head 102, and a handle 108 for moving vacuum cleaner 100 across the floor. A dirty air flow conduit comprising upstream portion 116 in cleaning head 102 and downstream portion in cyclone bin 120 extends from opening 112 in sole plate 114 to inlet 34 of cyclone 32. Upstream portion has an upstream end 124 positioned adjacent brush member 140 or the like and a downstream end 126. Downstream portion 118 has an upstream end 128 and a downstream end 130. A valve means 110 (eg. a rotatable valve as is known in the art) is provided adjacent downstream end 126 in cleaning head 102 so as to connect downstream portion 118 of the dirty air flow conduit in air flow communication with upstream portion 116 of the dirty air flow conduit when housing 106 is rotated rearwardly in the direction of arrow B in which position vacuum cleaner 100 is configured for use for cleaning a floor. In this embodiment, the cyclonic separator means uses one cyclone 32 comprising cyclone bin 120.

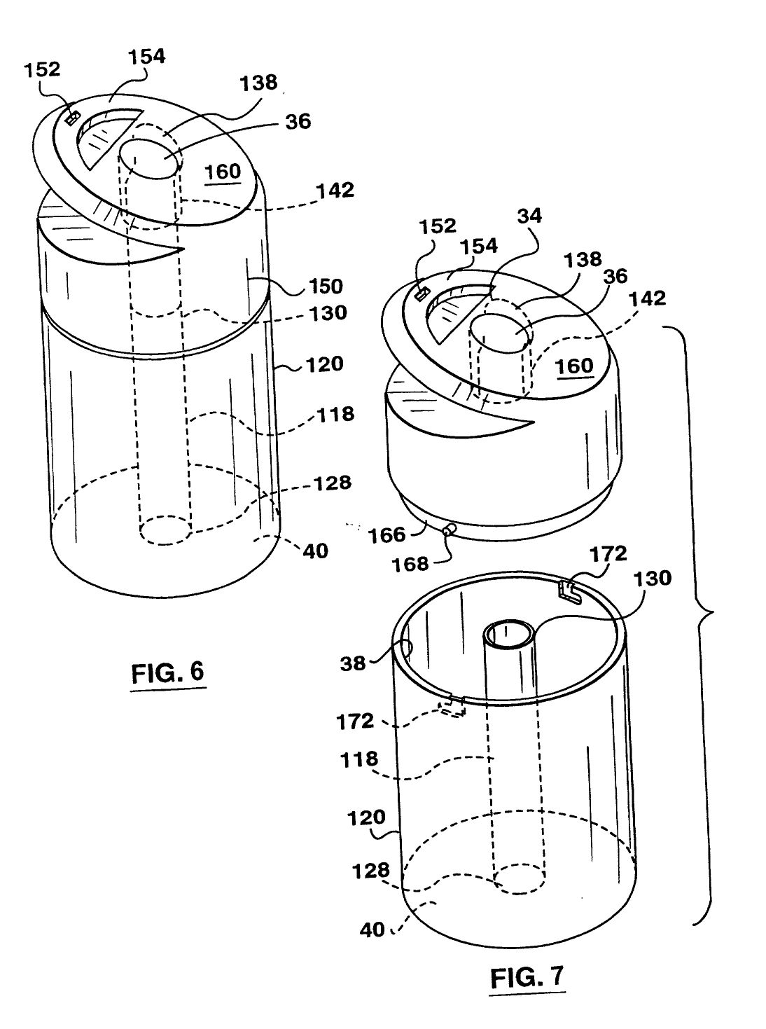

Cyclone bin 120 has an air inlet 34, preferably at upper end 136 thereof, adapted for providing an air flow tangentially to an inner dirt rotation surface or wall 38 of container 120. Air inlet conduit 138 may alternately be configured to provide an axial flow of air to container 120 and opening 34 at the downstream end of air inlet conduit 138 may have vanes to impart cyclonic flow to the air stream. Preferably, air inlet conduit 138 is configured to introduce the air tangentially to container 120. As shown in FIGS. 3 and 6, air inlet conduit 138 includes curved portions for redirecting the air from an axial flow in downstream portion 118 to a tangential flow at inlet 34. Air inlet conduit 138 curves gently from downstream end 130 of downstream portion 118 so as to travel outwardly and generally radially towards inlet 34. More preferably, the change in direction of the dirty air from generally vertical to generally horizontal and from generally horizontal to generally tangential occurs so as to reduce the pressure drop during its travel from downstream portion 118 to container 120.

Upstream and downstream portions 116 and 118 may comprise a single member (whether integrally formed or connected together to form a continuous flow path) in which case a separated dirt collection means may be positioned below container 120. Alternately portions 116 and 118 may be flexible so as to allow cyclone container 120 to be removed from housing 106 and emptied. In the preferred embodiment of FIGS. 2 and 3, upstream and downstream portions 116, 118 are separate elements and downstream portion 118 is removable with container 120 from housing 106 such that portions 116, 118 are in air flow communication when container 120 is mounted in housing 106 of vacuum cleaner 100. Thus, if a blockage develops in the dirty air flow conduit, by removing container 120 from housing 106 as shown in FIG. 5, portions 116 and 118 may be individually accessed at ends 126 and 128 to clean out the blockage. Preferably ends 126 and 128 are substantially sealed together to prevent air and dirt leaking there from.

Preferably, downstream portion 118 and container 120 are a one piece assembly so that when container 120 is removed from housing 106, downstream portion 118 is automatically removed at the same time. Thus, downstream portion 118 may be manufactured as part of container 120 (such as by moulding it integrally therewith). Alternately, it may be separately manufactured (such as by extrusion) and subsequently affixed to container 120 by any means known in the art (eg. by welding, engagement of male and female engagement members of the like).

In operation, the vacuum fan motor 122 is activated to induce an air flow through vacuum cleaner 100. The air flow causes a partial vacuum to form at end 124. Air, and entrained dirt, is drawn into upstream portion 116, with the aid of brush member 140. The dirty air flow moves vertically in downstream portion 118 to opening 34 in air inlet conduit 138 and is introduced tangentially to container 120. The airflow is then accelerated around wall 38 and proceeds generally downwardly along and around wall 38 until it reaches a position towards bottom 40 of container 120, at which point the air flow travels upwardly through the central portion of cyclone container 120. Wall 142, an extension of outlet 36, may be provided in container 120. Wall 142 assists in preventing the treated air travelling upwardly to outlet 36 from mixing with the dirty air which is introduced into container 120 via inlet conduit 138.

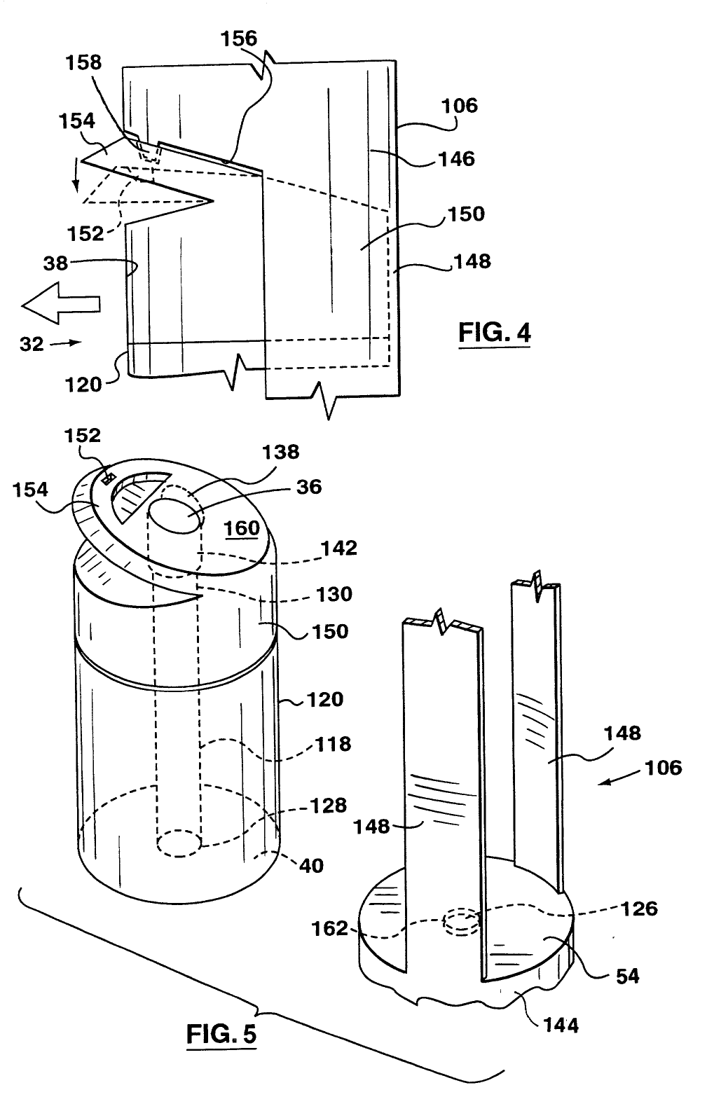

The removability of container 120 from housing 106 of vacuum cleaner 100 is shown by reference to FIGS. 4-7. Housing 106 comprises a base 144, an upper portion 146 and struts 148 which extend between base 144 and upper portion 146 of housing 106 so as to define a cavity within which container 120 is received. It will be appreciated that housing 106 may be of any configuration which provides an area in which bin 120 may be received. For example, it will be appreciated that if vacuum cleaner 100 is a canister vacuum cleaner, that container 120 may extend horizontally, or at any inclined angle to the horizontal and housing 106 may be of any shape within which container 120 may be received.

Container 120 may be lockingly received in housing 106 by any means known in the art. In the preferred embodiment, container 120 is provided with a lid 150 which has a recess 152 provided in handle 154 thereof. Container 120 and lid 150 comprise a cyclone chamber which is removable received in housing 106. Lower surface 156 of upper portion 146 of housing 106 is provided with a protrusion 158 which is receivable in recess 152. By moving handle 154 downwardly to the position shown in dotted outline in FIG. 4, protrusion 158 is removed from recess 152 allowing bin 120 to be removed from base 144 as is shown in FIG. 5. Recess 152 and protrusion 158 are a male and female detent means. It will be appreciated that other male and female detent means or the like which are known in the art may be utilized so that container 120 may be releasably lockingly received in housing 106.

The cleaned air travels upwardly out above container 120. Accordingly, lid 150 is provided with an upper surface 160. Cylindrical wall 142 extends downwardly from upper surface 160. The intersection of upper surface 160 and wall 142 describes opening 36 which is the clean air outlet.

As can be seen in FIG. 5, downstream portion 118 of the dirty air supply conduit is removed from housing 106 with container 120. Sealing means, such as O-ring 162 may be provided to join ends 126 and 128 in air flow communication when bin 120 is replaced in housing 106 so as to prevent any leak or any substantial leak where ends 126 and 128 meet.

Lid 150 may be releasably mounted to container 120 by any means known in the art such as a latch, a bayonet mount, a screw thread or the like. Referring to FIG. 7, lower end 164 of lid 150 is provided with a recessed surface 166 having two protrusions 168 provided therein. Upper end 170 of container 120 is provided with bayonet mounts 172 for receiving protrusions 168. Accordingly, once container 120 is removed from housing 106, lid 150 is rotated slightly counter clockwise so as to release the bayonet mount whereby lid 150 may then be lifted from container 120 thus allowing container 120 to be emptied.

The cleaned air after passing through the cyclone then preferably passes through an electrostatic cleaning stage. Thereafter, the further cleaned air may then pass directly through motor 122 and may then exit housing 106 via outlet 132 or it may first optionally pass through chamber 134, which may contain a further filtration means (eg. a HEPA™ filter) or a further electrostatic filtration means.

Electronic filter 50 may be positioned at any position in the dirty air flow path of the vacuum cleaner. For example, as shown in FIG. 3, it may be positioned downstream from first stage cyclone 32. Alternately, it may be positioned downstream from a second stage cyclone. Referring to FIG. 3, which uses only a single cyclone in the filtration means 30 of vacuum cleaner 100, filter 50 is positioned in cylindrical wall 142 of outlet 36. Accordingly, when cyclone bin 120 is removed from vacuum cleaner 100, filter 50 is automatically removed from vacuum cleaner 100 and is accessible for cleaning. If filter 50 is made from a water resistant material, filter 50 may be cleaned by placing filter 50 under a stream of running water (e.g. from a faucet). The water passing through filter 50 will remove particulate matter that is electrostatically attracted to members 210. It will be appreciated that filter 50 may also be positioned in cavity 214.

Electrostatic filter 50 may be removably receivably mounted in or above outlet 36 by any means known in the art such a by being secured therein by a friction fit, a screw thread, a bayonet mount, male and female engagement means or the like. Referring to FIG. 3, wall 142 has angled flange members 216 provided on the inner surface thereof on which filter 50 is seated. A locking means, such as a hinged flap or a deformable flange 218 may be used to lockingly hold filter 50 in position when the vacuum cleaner 100 is in operation. As shown in FIG. 18, a plate 242 which is secured to housing 208 by screws is used to lock electrostatic filter in lid 150.

In accordance with the instant invention, a novel construction for an electrostatic precipitator is provided. Referring to FIG. 8, in one embodiment, electrostatic precipitator 50 may comprise a plurality of spaced apart, electrically conductive members 180 which are positioned in series in an air flow path (e.g. they may have an opening 182 so as to be mounted around flow conduit 118 inside lid 150). In this way, after the air passes through cyclone bin 120, wherein part of the entrained dirt is removed, the remaining air will pass through electrically conductive members 180 as if they were a series of plates. The air will then exit through outlet 36 in bin lid 150. Accordingly, it will be appreciated that electrically conductive members 180 may be of any construction that will allow air to flow there through such as a porous plate, expanded metal and woven or non-woven conductive fibres or the like.

Spaced apart, electrically conductive members 180 may be a variety of construction provided that they have a conductivity which is selected to leave a residual charge on the particulate matter which is sufficient to retain the particulate matter in electrostatic filter 50. The residual charge on the particles may be from 700 volts to 10 Kv, preferably from 2.5 Kv to 7 Kv and, more preferably from 5 to 6 Kv.

If the particles are positively charged, then electrically conductive members 180 are at a charge state to donate electrons to neutralize part of the charge on the charged particles. Preferably, electrically conductive members 180 are at a ground state. It will be appreciated that given the relative size of particulate matter entrained in a fluid stream and the size of a single electrically conductive member 180, that electrically conductive members 180 effectively operate as a ground, whether they are in fact grounded or not. By inhibiting the complete neutralization of a charged particle, a residual charge will be maintained which, provided the air flow is not to strong through electrostatic filter 50, retains the particles in electrostatic precipitator 50. It will be appreciated that the higher the air flow velocity, the greater the residual charge should be.

Various constructions may be utilized to produce such a residual charge. In these embodiment, the member 180 has a conductivity which is selected to leave the desired residual charge on the entrained particles. In particular, the members themselves may have a limited conductivity such that a charged particle will not be completely neutralized by electrically conductive members 180. Electrically conductive members 180 may be constructed in a variety of manners to produce this result. In one embodiment, electrically conductive members may be constructed from a conductive material of limited conductivity. In an alternate embodiment, the electrically conductive material may be coated with an electrical insulating layer so as to limit the transfer of electrons between the charged particles and the electrically conductive material thereby leaving a residual charge on the particles. Examples of such electrical insulating layers include an oxide of silicone, a plastic, a dielectric, a ceramic and a combination thereof. While the electrically conductive material may be a metal, it will be appreciated that other electrically conductive materials, such as electrically conductive ink may be utilized. A preferred metal for use in constructing electrically conductive members 180 is aluminium. A protective coating of aluminium oxide, approximately 50 angstroms thick, forms on aluminium and provides this layer.

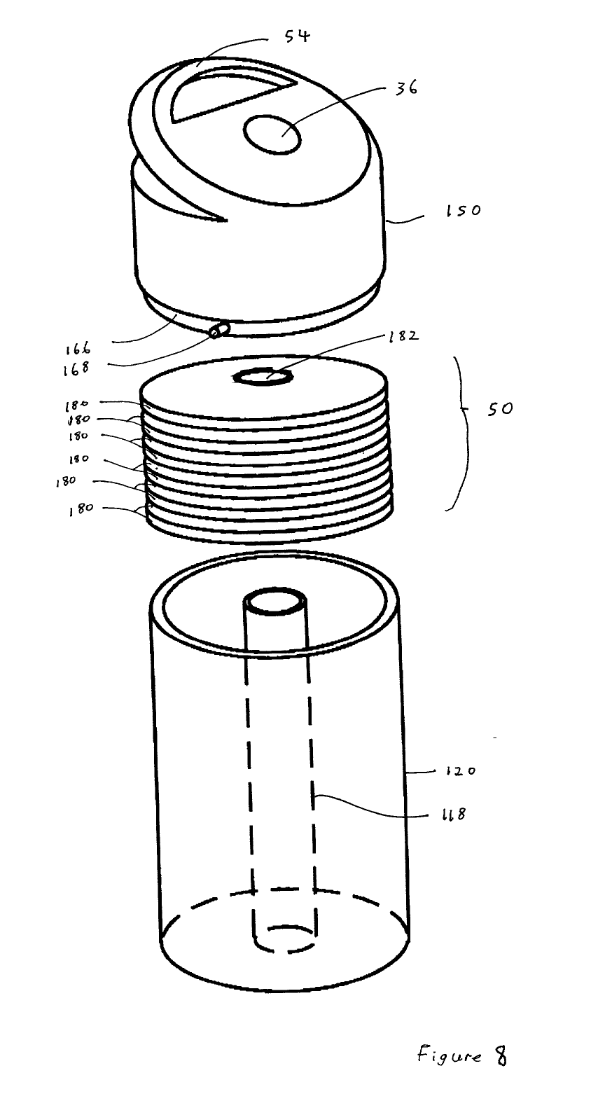

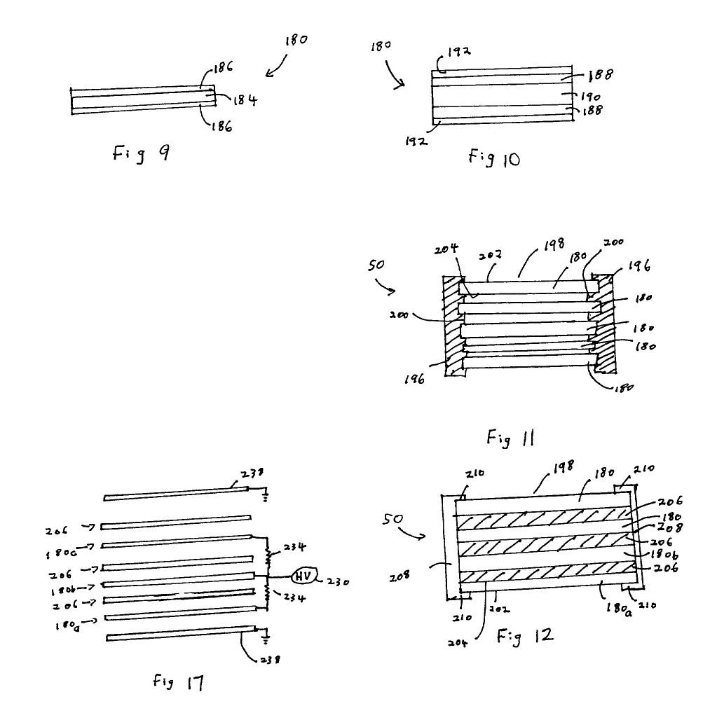

Examples of alternate embodiments for electrically conductive members 180 are shown in FIGS. 10 and 11. Referring to FIG. 9, electrically conductive member 180 is constructed from a conductive metal 184 which is coated, preferably on both sides, with a plastic layer 186. Referring to FIG. 10, an electrically conductive material is coated onto a substrate 190. In this embodiment, the electrically conductive material 188 is a conductive ink and substrate 190 is formed from cardboard. Conductive ink 188 is coated with a dielectric 192 to limit the effectiveness of conductive ink 188 as an electrical conductor. It will be appreciated that substrate 190 is selected to provide a suitable physical support member for receiving a conductive material. Substrate 190 may be formed from any material (e.g. a plastic, a dielectric, a non-productive metal or even a conductive metal) provided it provides sufficient physical strength for the application which electrostatic precipitator 50 is utilized. Conductive layer 188 may be deposited by any means known in the art on substrate 190. For example, it may be coated on as in the case of a conductive ink, it may be a vapour deposition of metal on a plastic substrate (e.g. metallized Mylar™) or a conductive layer which is applied by an adhesive or the like to a suitable substrate. In any of these constructions, an electrically conductive member 180 is fashioned such that the free flow of electrons is limited so that a charge differential will exist between a particle and electrically conductive member 180 such that the particle will tend to stay affixed to electrically conductive member 180 despite the air flow through electrostatic precipitator 50. Accordingly, it will be appreciated that this construction forms an electrostatic precipitator regardless of whether conductive metal 184 or conductive layer 180 is grounded.

Pursuant to these embodiments, electrostatic filter 50, as shown in FIG. 8, is constructed from a plurality of layers 180 positioned in series and preferably immediately adjacent each other. For example, electrostatic filter 50 may comprise from 1 to 200 layers of electrically conductive material 180, preferably from 20 to 80 layers and, more preferably from 40 to 100 layers. The layers define a gas flow path through electrostatic filter 50. Various different constructions may be utilized to produce a fluid flow path. In the preferred embodiment shown in FIG. 50, each layer 180 is constructed of a porous material such that the gas passes through each layer 180 sequentially. Accordingly, while a particular charged particle may not be retained in the first or second layers through which it passes, provided a sufficient number of layers 180 are provided, then statistically, essentially all of the charged particles entering electrostatic precipitator 50 will be retained. In this way, it has been possible to construct an electrostatic precipitator which will retain approximately 99% of the charged particles passing there through.

Each layer 180 is preferably constructed from any porous material which provides a high surface area for interaction between charged particles and the electrically conductive material. More preferably, the material does not create an excessive back pressure (e.g. expanded metal or wool). Accordingly, layers 180 may be constructed with holes provided therein to define an air flow path. Preferably, the holes are not aligned one with another so as to force the gas to change direction repeatedly as it travels through electrostatic precipitator 50. In this way, the kinetic energy of the charged particles may be used to enhance the effectiveness of electrostatic precipitator 50. In particular, as the charged particles pass through electrostatic precipitator 50, the differential in the charge on the charged particle and layer 180 will produce a force so as to bring a charged particle into proximity with a layer 180 so as to partially neutralize the charge on the charged particle. The electrostatic attractive force may not be sufficient to attract a particle to a particular layer. However, if the charged particle undergoes repeated changes in direction, the statistical likelihood that a charged particle will come into sufficient proximity to a layer 180 so that the charged particle will be substantially neutralized is increased. To this end, layer 180 may be constructed by a woven or non-woven porous conductive material, expanded metal or a plurality of tightly packed conductive elements which define openings of limited size.

The air flow path is preferably constructed such that the spacing between charged portions of a layer 180 or between adjacent surfaces of adjacent layers 180 is limited. The actual spacing which should be utilized will vary depending upon several factors including the degree to which the particles are charged and the speed with which the particles are travelling. The higher the speed, then preferably the closer the spacing. However, the greater the charge which has been applied to the particles prior to entering electrostatic precipitator 50, then the greater the spacing may be. For example, if the particles are charged to, for example, 15 to 20 Kv and are travelling at about 2.5 m/s, then the spacing between the charged portions is preferably not more than 0.5 inches, preferably not more than 0.25 inches and more preferably not more than 0.1 inches. However, if the particles are travelling at a higher rate of speed, e.g. 7.5 m/s, then the spacing is preferably not more than 0.075 inches. In addition, the higher the voltage of the charged particles entering electrostatic precipitator 50, then the greater the spacing may be between charged portions of layers 180.

The particles themselves may be charged by any means known in the art. For example, the particles may be charges as a result of an industrial process which occurs upstream from electrostatic filter 50. Alternately, the particles may be passed through a charged field so as to charge them whereby the particles may subsequently be removed by electrostatic precipitator 50. In the application of electrostatic precipitator 50 in a vacuum cleaner, the particles are preferably charged by tribocharging. As the particles travel through a cyclone, such as cyclone 32, the particles will interact with inner surface of wall 38 of cyclone 32 thereby charging the particles in the air stream. The charge in the particles will dissipate as the particles travels through the vacuum cleaner. However, a substantial charge will remain as the particles exit the vacuum cleaner. The particles may be charged so as to have a voltage of from about 20 to about 60 kv but may have a charge as low a about 1 Kv.

In accordance with another aspect of the instant invention, the electrostatic precipitator 50 of FIG. 11 is provided with a plurality of non-conductive layers 206 interspersed between at least some electrically conductive members 180 and, preferably between all adjacent electrically conductive members 180. Referring to FIG. 12, a non-conductive porous layer is sandwiched between opposed conductive layers 180. The plurality of layers 180 and 206 are secured together by any means known in the art, such as being mounted between abutment members 210 of housing 180. It will be appreciated that layers 180 and 206 may be joined together in a one piece assembly by any other means known in the art such as non-conductive tie rods that extend longitudinally through electrostatic precipitator 50, an adhesive provided at the edges, a housing in which the layers are received or the like. The layers may be mounted in a housing 208 Preferably, housing 208 is an insulating member, e.g. plastic so that filter 50 is electrically insulated. In operation, as charged particles pass through flow path 198, they will inductively charge electrically conductive layers 180. In this way, the first layer 180A will become, e.g., negatively charged and induce an opposite charge (e.g. a positive charge) on the next adjacent layer 180B.

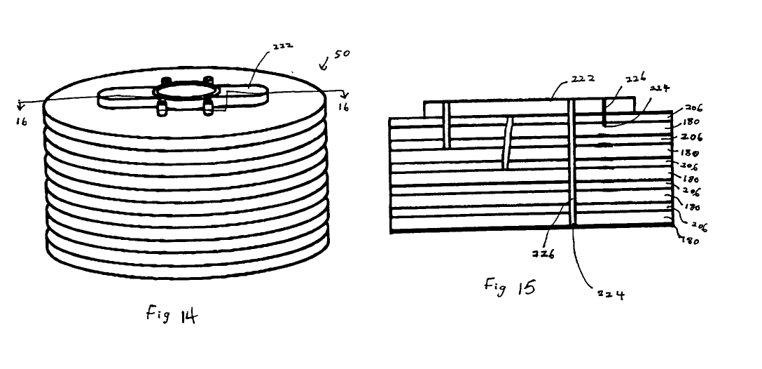

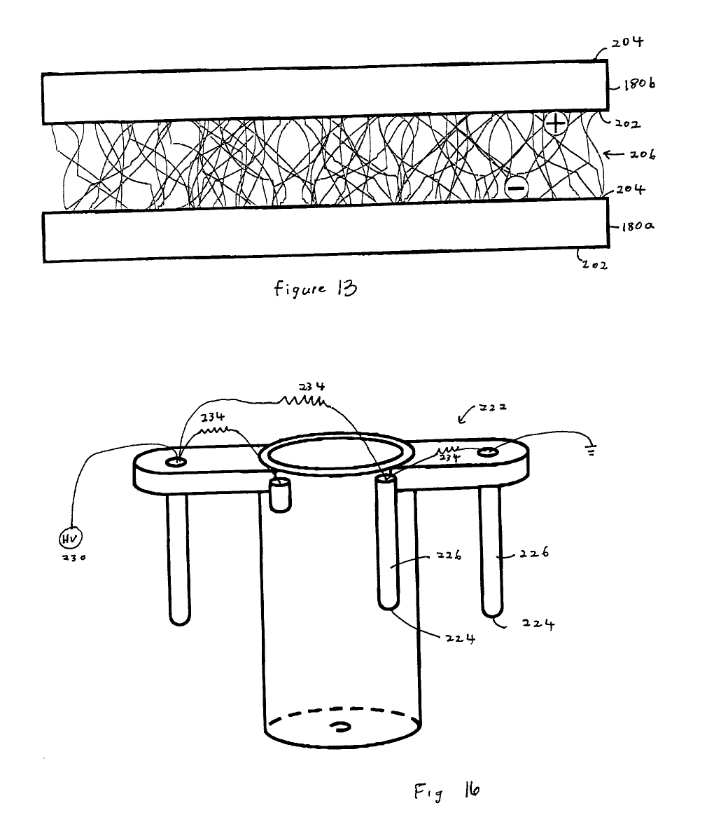

In accordance with another embodiment of the instant invention, electrical conductive members 180 may themselves be actively charged. An example of such an embodiment is shown in FIGS. 14-16. Referring to FIG. 15, electrostatic precipitator 50 comprises alternating porous layers or plates of a conductive material 180 and a non-conductive or dielectric material 206. Adjacent conductive layers are charged to different potentials so as to produce a weak charge in the non-conductive layer which is preferably of the same magnitude as the residual charge discussed previously.

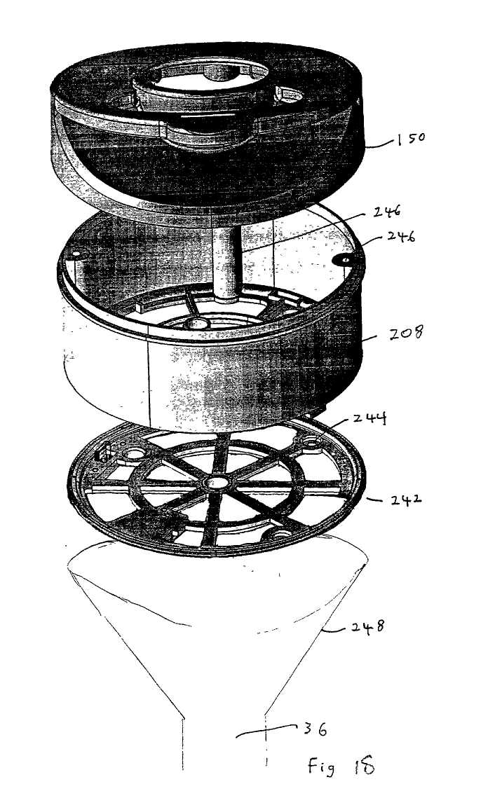

Each layer 180 is at a different potential so as to polarize opposed sides of layer 206 as is shown in FIG. 13. For example, referring to the embodiment of FIG. 17, each electrically conductive layer 180 is electrically charged by a single high voltage source 230. The high voltage source is connected to layers 180 such that adjacent layers 180 are at different potentials. For example, layer 180B may be directly connected to high voltage source 230 and the adjacent layers 180A and 180C may be connected to high voltage source 230 by resistors 234 to thereby produce the potential of conductive layers 180A and 180C. For example, layer 180 may be charged to −5 Kv whereas layers 180A and 180C may be charged to −2.5 Kv. Thus, while a single high voltage source is used, charged particles will be exposed to different potentials as they travel through the electrostatic precipitator. Porous ground plates 238 are preferably provided to prevent a user from accidentally touching a charged plate 180A,C. Non-conductive porous layers 206 are provided between adjacent charge plates 180. While all plates 180 are all of the same polarity (e.g. negatively charged), they are at different potentials. This will cause a porous layers 206 to become polarized. In particular, as shown in FIG. 13, the surface of layer 206 adjacent plate 180B will become positively charged whereas the portion of the same layer 206 adjacent plate 180A will become negatively charged. The reason for this is that electrons will tend to migrate in layer 206 due to the different polarities which are provided on opposed plates 180A and 180B. Preferably, adjacent plates 180 have a difference in potential of at least 1 Kv and, more preferably from about 1 to 2.5 Kv. In another embodiment, adjacent electrically conductive plates 180 may have a difference in potential of at least about 10%.

In a preferred embodiment, porous layer 206 is made from a dielectric material or the like. As shown in FIG. 13, if plate 180A is positively charged and plate 180B is negatively charged, then electrons will be induced to flow in non-conductive porous layer 206 such that a relatively weak negative charge will be formed in the portion of layer 106 adjacent surface 204 of positively charged plate 180 and a relatively weak positive charge will be formed adjacent surface 202 of negatively charged plate 180B. When charged particles contact an oppositely charged layer of porous layer 206, a residual charge will be maintained in the particle (since layer 206 is a poor conductor) thereby resulting in the particles tending to remain in layer 206 despite the air flow thereto.

Layers 180 may be charged by any means known in the art. For example, layers 180 may be individually connected to different sources of current. As shown in FIG. 15, mount 222 is provided. Mount 222 comprises a plurality of posts 226 each of which electrically connects one or more layers 180 to a source of current. In the embodiment of FIG. 15, each post 226 has an electrode 224 which engages a single layer 180.

In the embodiment of FIG. 17, the electrically conductive plate 180 having the highest potential is connected to the high voltage source and the other electrically conductive members 180 are charged by the same current source but to different potentials. In an alternate embodiment however, some or the remainder of plates 180 may be inductively charged by the plates which are connected to high voltage source 230. In this way, plates 180 which are not connected to a current source may be charged by current leakage.

In a further alternate embodiment, electrostatic precipitator 50 is constructed from a plurality of electrically conductive members 180 which are electrically insulated from a ground and are electrically insulated from each other. In such a case, the charged particles may be used to inductively charge electrically conductive members 180. As electrically conductive members 180 are electrically insulated, they may be constructed from any electrically conductive material known in the art and need not be coated with a plastic, dielectric, ceramic or the like. Accordingly, in this construction, electrically conductive members 180 may be constructed from, for example, stainless steel. Preferably, the metal is coated with a dielectric or the like as discussed previously. An example of this construction is shown in FIG. 10.

As shown in FIG. 11, electrostatic precipitator 50 comprises a plurality of porous electrically conductive layers 180 which are secured in position by insulating support member 196. For example, insulating support member 196 may be a cylindrical member which is constructed from plastic and therefore moulded. Layers 180 may be made, for example, from a porous electrically conductive material, e.g. steel wool or extended steel. Each layer 180 is secured in position in insulating support 196 by engagement of abutment members 200 with first and second opposed surfaces 202, 204 of layers 180 (or other means known in the art). Layers 180 preferably have sufficient structural integrity, or are spaced sufficiently far apart, such that the first opposed surface 202 of one layer of 180 does not contact second opposed surface 204 of an adjacent layer 180. A gas contained entrained particles passes sequentially through layers 180 as it travels through flow path 198. Initially, layers 180 may have no charge. However, as the charged particles pass through flow path 198, they will pass through layers 180 and charge them. The charging may occur in one of two fashions. First, if particles contact a plate 180, then electrons will travel to neutralize the charge of the particles thereby charging the plate. Alternately, the plates may be inductively charged as the particles pass there through. This embodiment is particularly useful when utilized with charged particulate matter the itself is a dielectric such that the charge on the particulate matter is completely neutralized by the conductive elements. Instead, a residual charge is left on the particulate matter.

Referring to FIG. 18, an embodiment of a housing for electrostatic filter 50 for use in a vacuum cleaner is shown. Housing 208 has an internal cavity for receiving electrostatic precipitator 50. Housing 208 is provided with a bottom plate 242 and secured thereto by a plurality of screws which extend through screw holds 244 and are received in screw mounts 246. In order to improve the efficiency of electrostatic precipitator 50, the cross sectional area of the air flow path is increased from outlet 36 to the bottom of electrostatic precipitator 50 (i.e. adjacent bottom 242) such as by means of diffuser 248 which is configured as an inverted funnel. In this way, the rate of travel of the air flow will be reduced as it passes through electrostatic filter 50.

In another embodiment, the vacuum cleaner may be powered by battery 220 (see FIG. 5).

It will be appreciated by those skilled in the art that various additions and modifications may be made to the instant invention and all of these are within scope of the following claims.

We claim:

1. A vacuum cleaner comprising:
(a) a vacuum cleaner head having a dirty air inlet and an air flow path there through for transporting particulate material entrained in air passing through the air flow path, the air flow path in fluid flow communication with a source of suction: and,
(b) a filter assembly comprising a plurality of spaced apart, electrically conductive members defining an air flow path through the electronic filter, and at least one porous, non-conductive spacing member positioned in the air flow path between at least two adjacent electrically conductive members, each porous, non-conductive spacing member having first and second opposed sides, the first opposed side positioned adjacent a first electrically conductive member and the second opposed side positioned adjacent a second electrically conductive member wherein, in use, the first and second electrically conductive members have different potentials sufficient to produce polarized charges at the first and second opposed surfaces of a spacing member.

2. The vacuum cleaner as claimed in claim 1 wherein the electrically conductive members comprise porous electrically conductive plates.

3. The filter assembly as claimed in claim 1 wherein the electrically conductive plates are constructed from expanded metal.

4. The vacuum cleaner as claimed in claim 1 wherein the air flow path is a convoluted path.

5. The vacuum cleaner as claimed in claim 2 wherein the electrically conductive porous plates are chargeably connected to a current source.

6. The vacuum cleaner as claimed in claim 2 further comprising a charging member to charge the particulate material whereby the electrically conductive porous plates are inductively charged by the particulate material.

7. The vacuum cleaner as claimed in claim 2 further comprising a cyclone whereby the particulate material is tribocharged during its passage through the cyclone and the electrically conductive porous plates are inductively charged by the particulate material.

8. The vacuum cleaner as claimed in claim 1 wherein the electrically conductive members are of the same polarity.

9. The vacuum cleaner as claimed in claim 1 wherein the electrically conductive members and the non-conductive spacing members define an electronic filter which has an upstream end, a downstream end and a central portion and the central portion is operated at a higher potential then the downstream end.

10. The vacuum cleaner as claimed in claim 9 wherein the central portion is operated at a higher potential then the downstream end and the upstream end.

11. The vacuum cleaner as claimed in claim 1 wherein adjacent electrically conductive members have a difference in potential of at least 1,000 volts.

12. The vacuum cleaner as claimed in claim 1 wherein adjacent electrically conductive members have a difference in potential which varies from about 1,000 to 2,500 volts.

13. The vacuum cleaner as claimed in claim 1 wherein adjacent electrically conductive members have a difference in potential of at least 10%.

14. The vacuum cleaner as claimed in claim 1 wherein one electrically conductive member having the highest potential is connectable to a high voltage source and the other electrically conductive members are electrically connected to the plate having the highest potential via at least one resistor whereby the flow of the current through the at least one resistor reduces the voltage of the current provided to the other plates.

15. The vacuum cleaner as claimed in claim 1 wherein one electrically conductive member having the highest potential is connectable to a high voltage source and the other electrically conductive members are charged by selecting the non-conductive layer to permit current leakage to pass there through whereby the other plates are charged by the current leakage.

16. The vacuum cleaner as claimed in claim 1 wherein the electrically conductive members and the non-conductive spacing members define an electronic filter and the electronic filter has an upstream end and a downstream end and a ground electrode is positioned adjacent the upstream end and the downstream end.

17. An electronic filter having an upstream end and a downstream end, the electronic filter comprising:
(a) a plurality of spaced apart, electrically conductive porous plates, each plate having an upstream side and a downstream side; and,
(b) a porous dielectric layer positioned between adjacent conductive plates, each electrically insulating layer having an upstream side and a downstream side.

18. The electronic filter as claimed in claim 17 wherein each electrically insulating layer comprises a plurality of non-conductive fibres.

19. The electronic filter as claimed in claim 17 wherein the plates are of the same polarity.

20. The electronic filter as claimed in claim 17 wherein the filter has an upstream end, a downstream end and a central portion and the central portion is operated at a higher potential then the downstream end.

21. The electronic filter as claimed in claim 17 wherein the filter has an upstream end, a downstream end and a central portion and the central portion is operated at a higher potential then the downstream end and the upstream end.

22. The electronic filter as claimed in claim 17 wherein adjacent plates have a difference in potential of at least 1,000 volts.

23. The electronic filter as claimed in claim 17 wherein one plate having the highest potential is connectable to a high voltage source and the other plates are electrically connected to the plate having the highest potential via at least one resistor whereby the flow of the current through the at least one resistor reduces the voltage of the current provided to the other plates.

24. The electronic filter as claimed in claim 17 wherein one plate having the highest potential is connectable to a high voltage source and the other plates are charged by selecting the electrically insulating layer to permit current leakage to pass there through whereby the other plates are charged by the current leakage.

25. A method of filtering a gas containing entrained material comprising the step of sequentially passing the gas through a plurality of non-conductive members which are interspersed between zones of different potential wherein adjacent zones have a potential difference sufficient to induce different polarities on different portions of a non-conductive filter member positioned between the adjacent zones.

26. The method as claimed in claim 25 wherein the zones of different potential are of the same polarity and the method further comprises passing the gas through zones of different potential but of the same polarity.

27. The method as claimed in claim 25 wherein the polarity of the zones alternates between adjacent non-conductive members and the method further comprises passing the gas through zones of different polarity.

28. The method as claimed in claim 25 further comprising the step of tribocharging the entrained material prior to passing the gas through the filter.

29. A vacuum cleaner comprising:
(a) a vacuum cleaner head having a dirty air inlet and an air flow path there through for transporting particulate material entrained in air passing through the air flow path, the air flow path in fluid flow communication with a source of suction: and,
(b) a plurality of spaced apart, electrically conductive members positioned in series in the conduit, the electrically conductive members having a conductivity selected to leave a residual charge on the particulate matter which is sufficient to retain particulate matter on the electrically conductive members.

30. The electronic filter as claimed in claim 29 wherein the electrically conductive members comprise porous electrically conductive plates.

31. The vacuum cleaner as claimed in claim 29 further comprising a charging member to charge the particulate material whereby the electrically conductive members are inductively charged by the particulate material.

32. The vacuum cleaner as claimed in claim 29 further comprising a cyclone whereby the particulate material is tribocharged during its passage through the cyclone and the electrically conductive members are inductively charged by the particulate material.

33. An electronic filter comprising:
(a) a conduit defining a gas flow path through which a gas having entrained particulate matter travels; and,
(b) a plurality of spaced apart, electrically conductive members positioned in the conduit, the electrically conductive members having a conductivity selected to leave a residual charge on the particulate matter which is sufficient to retain the particulate matter in the electronic filter.

34. The electronic filter as claimed in claim 33 wherein the electrically conductive members comprise porous electrically conductive plates.

35. The electronic filter as claimed in claim 33 wherein the electrically conductive members are constructed from a conductive material which is coated with an electrical insulating layer.

36. The electronic filter as claimed in claim 35 wherein the coating is selected from the group consisting of an oxide of silicon, plastic, a dielectric, a ceramic and a combination thereof.

37. The electronic filter as claimed in claim 33 wherein the electrically conductive members are constructed from aluminum.

38. The electronic filter as claimed in claim 33 wherein the electrically conductive members are electrically insulated from a ground such that the particulate matter inductively charges the plates as it passes through the electronic filter.

39. The electronic filter as claimed in claim 38 wherein the electrically conductive members are constructed from stainless steel.

40. The electronic filter as claimed in claim 33 wherein the residual charge is from 700 v to 10 Kv.

41. The electronic filter as claimed in claim 33 wherein the residual charge is from 2.5 to 7 Kv.

42. The electronic filter as claimed in claim 33 wherein the residual charge is from 5 to 6 Kv.

43. The electronic filter as claimed in claim 33 wherein the gas flow path is a convoluted path through the electronic filter.

44. The electronic filter as claimed in claim 34 wherein the plates are constructed from aluminum mesh and electronic filter comprises from 1-200 plates.

45. The electronic filter as claimed in claim 34 wherein the plates are constructed from aluminum mesh and electronic filter comprises from 20-120 plates.

46. The electronic filter as claimed in claim 34 wherein the plates are constructed from aluminum mesh and electronic filter comprises from 40-100 plates.

47. An electronic filter comprising:
(a) conduit means extending through the electronic filter through which a gas having entrained particulate matter travels; and,
(b) electrically conductive means positioned in the conduit means, the electrically conductive means having a conductivity selected to leave a residual charge on the particulate matter which is sufficient to retain particulate matter on the electrically conductive means.

48. The electronic filter as claimed in claim 47 wherein the electrically conductive means define a series of porous members which are positioned such that the gas flows through several of the porous members as it travels through the electronic filter.

49. The electronic filter as claimed in claim 47 wherein the electrically conductive means are coated with an electrical insulating layer.

50. The electronic filter as claimed in claim 49 wherein the coating is selected from the group consisting of an oxide of silicon, plastic, a dielectric, a ceramic and a combination thereof.

51. The electronic filter as claimed in claim 47 wherein the electrically conductive means are constructed from aluminum.

52. The electronic filter as claimed in claim 47 further comprising means for electrically insulating the electrically conductive means from a ground such that the particulate matter inductively charges the plates as it passes through the electronic filter.

53. The electronic filter as claimed in claim 52 wherein the electrically conductive members are constructed from stainless steel.

54. The electronic filter as claimed in claim 47 where in the conduit means is a convoluted path through the electronic filter.

55. The electronic filter as claimed in claim 47 wherein the plates are constructed from aluminum mesh and electronic filter comprises from 1-200 plates.

56. A method of filtering a gas containing entrained particulate matter comprising the steps of providing a gas containing charged entrained particulate matter and passing the gas through a plurality of electrically conductive members whereby the potential on the conductive members and the conducitivity of the entrained particulate matter leave a residual charge on the particulate matter which is sufficient to retain the particulate matter on the electrically conductive members.

57. The method as claimed in claim 56 wherein the entrained particulate matter has the conductivity of the particulate matter is that of a dilelectric element.

58. The method as claimed in claim 56 wherein the electrically condcutive members are electrically insulated from each other and are inductively charged by the passage of entrained particulate matter therethrough.

59. The method as claimed in claim 58 further comprising the step of tribocharging the entrained material prior to passing the gas through the filter.
